(19) United States
(12) Patent Application Publication
(10) Pub. No.: US 2022/0212860 A1
(43) Pub. Date: Jul. 7, 2022

(54) CAPSULE CONTAINING MATERIAL SUCH AS BEVERAGE POWDER, IN PARTICULAR FOR PREPARING BREWED COFFEE

(71) Applicant: SWISS COFFEE INNOVATION AG, Olten (CH)

(72) Inventor: Axel NICKEL, Hemmingen (DE)

(21) Appl. No.: 17/608,613

(22) PCT Filed: Apr. 21, 2020
(86) PCT No.: PCT/EP2020/061094

§ 371 Date: Nov. 3, 2021

(30) Foreign Application Priority Data
May 7, 2019 (EP) 19172933.4

(51) Int. Cl. B65D 85/804; B65D 65/46; B65B 29/02

(52) U.S. Cl. CPC B65D 85/8043; B65B 29/022; B65D 65/466

(57) ABSTRACT

A capsule containing a beverage powder is particularly useful for preparing a beverage, such as preparing coffee from ground coffee by introducing water into the capsule. In one example, the capsule includes a capsule body composed of at least one polysaccharide and the capsule body is filled with a powder containing polysaccharide. The capsule body is encased all around by at least one coating layer that contains at least one polyvinyl alcohol and/or a polyvinyl alcohol copolymer.

The present invention relates to a capsule containing a material, such as beverage powder, which is particularly suitable for the preparation of a beverage, such as cocoa, tea or coffee. In addition, the present invention relates to a method of manufacturing such a capsule and to the use of such a capsule.

In recent years, coffee capsules, whose capsule walls are usually made of stainless steel, aluminium or plastic, have been increasingly used alongside coffee pods for the portion-wise preparation of beverages, especially brewed coffee. Such capsules allow coffee powder to be stored for a longer period of time without loss of aroma. Moreover, such capsules allow a quick and user-friendly preparation of a coffee portion with a desired flavor by inserting a capsule with a desired type of coffee into a coffee machine adapted thereto, in which hot water is then pressed through the capsule and brewed coffee is produced therefrom. However, such capsules are comparatively expensive due to, among other things, the capsule material used and the production-intensive capsule construction. Furthermore, such capsules are environmentally problematic. On the one hand, the capsules are not recyclable and are usually disposed of as residual waste by the consumer after use. Recycling of coffee capsules is therefore practically non-existent, which is particularly worrying in the case of aluminium-based coffee capsules, as aluminium production is very energy-intensive, resulting in a particularly poor CO₂ balance for such capsules.

Another major disadvantage is that such capsules are not biodegradable and thus cannot be biologically disposed. Considering the fact that in Germany alone well over 4 billion coffee capsules are consumed per year, this is a serious problem.

The same problems are also associated with other packaging, such as transport packaging, food packaging and the like.

In order to at least partially circumvent the above problems for such capsules, capsules made of alternative materials have already been proposed.

From DE 10 2014 000 187 B4 a capsule is known which consists of a pellet of a cellulosic powder, such as in particular coffee powder, wherein the pellet is coated with a layer composed of a biodegradable material. The coating layer is preferably a liquid cellulose consisting of a polysaccharide or a derivative thereof in combination with a polyol spacer and the associated crosslinking agent.

EP 3 115 316 B1 discloses a capsule, in particular for preparing a beverage from beverage powder, in particular coffee from coffee powder, by introducing water into the capsule, wherein the capsule comprises a pellet of a powder containing at least one polysaccharide, wherein said pellet is coated with at least one coating layer, said at least one coating layer comprising a crosslinked polysaccharide, said crosslinked polysaccharide having been obtained by crosslinking a polysaccharide with a crosslinking agent without the use of a polyol spacer.

EP 3 225 566 B1 discloses a capsule, in particular for preparing a beverage from beverage powder, in particular coffee from coffee powder, by introducing water into the capsule, wherein the capsule consists of a capsule body containing at least one polysaccharide, filled with a powder containing at least one polysaccharide, said capsule body being coated with at least one coating layer, said at least one coating layer comprising a crosslinked polysaccharide, said crosslinked polysaccharide having been obtained by crosslinking a polysaccharide with a crosslinking agent.

These capsules are easily biodegradable and thus environmentally friendly. However, the aroma protection or oxygen impermeability of the coatings derived from biological sources is in need of improvement. Although the impermeability can be increased by multiple coating, as a rule additional secondary packaging must be used which have sufficient aroma protection and oxygen impermeability.

Based on this, the present invention is based on the task of providing a capsule, in particular for the portion-wise preparation of beverages from beverage powder, such as cocoa, tea and coffee, which is not only easy and inexpensive to produce, biodegradable and therefore environmentally friendly to dispose of, but which also protects the capsule contents from significant loss of aroma over a longer period of time and avoids a change in taste due to oxidation caused by oxygen.

According to the invention, this task is solved by a capsule, in particular for preparing a beverage from beverage powder, in particular coffee from coffee powder, by introducing water into the capsule, comprising a capsule body composed of at least one polysaccharide and filled with a polysaccharide-containing material, the capsule body being entirely encased by at least one first coating layer, the at least one first coating layer comprises at least one polyvinyl alcohol and/or a polyvinyl alcohol copolymer.

A major advantage of this solution is that such a capsule consisting of a capsule body composed of at least one polysaccharide and filled with a polysaccharide-containing material, wherein the capsule body is coated over its entire surface with at least one first coating layer, wherein the at least one first coating layer contains at least one polyvinyl alcohol and/or a polyvinyl alcohol copolymer, can be disposed of in an environmentally friendly manner and furthermore has transport protection and touch protection. Moreover, this solution is based on the realization that such a capsule has all the necessary properties required for its use for portion preparation of beverages, such as coffee. In particular, the capsule is able to withstand even high pressures such as those that may occur during the preparation of a brewed beverage, due to its high stability, which provides it with a sufficiently high level of transport protection and protection against being touched. Apart from this, the capsule according to the invention protects the capsule contents due to the at least one first coating layer of polyvinyl alcohol and/or polyvinyl alcohol copolymer also over a longer period of time without any loss of aroma, let alone any appreciable loss of aroma, and also protects them from a change in taste due to oxidation caused by oxygen, because the at least one coating layer of polyvinyl alcohol and/or polyvinyl alcohol copolymer is characterized by an outstandingly low gas permeability. Apart from this, the capsule according to the invention is easy and inexpensive to manufacture. Moreover, it is particularly essential that both the capsule body and the at least one first coating layer are non-toxic and biodegradable.

With respect to the polysaccharide-containing material with which the capsule body of the capsule according to the invention is filled, the present invention is not particularly limited. In particular, the material may be a liquid, a paste or a solid at room temperature. In particular, good results are obtained when the capsule body is filled with a polysaccharide-containing material which is suitable as a powdered beverage. Particularly suitable examples are those selected from the group consisting of coffee, tea, drinking chocolate, cocoa and milk powder.

In particular, good results are obtained when the capsule body is filled with ground coffee powder.

Polysaccharide in this sense is to be understood very broadly and includes all saccharides in which two or more monosaccharides are linked via glycosidic bond(s). Thus, the term polysaccharide within the meaning of the present patent applications also includes, in particular, bi-, tri- or tetrasaccharides, such as the disaccharide lactose, which is an essential component of milk powder.

According to a first embodiment of the present invention, the at least one first coating layer is entirely or at least substantially composed of one or more polyvinyl alcohols and/or one or more polyvinyl alcohol copolymers. For example, the at least one first coating layer may be at least 50% by weight, preferably at least 75% by weight, more preferably at least 90% by weight, most preferably at least 98% by weight, and most preferably entirely composed of one or more polyvinyl alcohols and/or one or more polyvinyl alcohol copolymers.

To adjust the desired mechanical properties, the at least one first coating layer may comprise, in addition to the one or more polyvinyl alcohols and/or one or more polyvinyl alcohol copolymers, other components, such as in particular one or more additives. According to this embodiment, the at least one first coating layer is preferably composed of at least 50% by weight, and more preferably at least 75% by weight, of one or more polyvinyl alcohols and/or one or more polyvinyl alcohol copolymers, and further comprises one or more additives, such as preferably comprises at least one additive selected from the group consisting of talc, glycerol, polyethylene glycol and any mixtures of two or more of the aforementioned additives. By mixing in glycerol or polyethylene glycol, the elasticity of the at least one first coating layer can be improved and by adding talc, the mechanical stability of the at least one first coating layer can be adjusted to a desired value.

In order to achieve a sufficiently low gas permeability, it is proposed, in further development of the idea of the invention, that the at least one first coating layer has a thickness of from 0.5 to 10 μm, preferably from 1 to 5 μm, and more preferably from 1 to 2 μm. The feature that the capsule comprises at least one first coating layer means that the capsule comprises one or two or more interconnected layers of at least one polyvinyl alcohol and/or one polyvinyl alcohol copolymer, that is a corresponding single layer or laminate of two or more layers applied on top of each other. When the capsule comprises two or more first coating layers, the above thickness is the total thickness of all the first coating layers.

Preferably, the capsule has from 1 to 5, more preferably from 1 to 3, most preferably 1 or 2, and most preferably one layer(s), each comprising at least one polyvinyl alcohol and/or polyvinyl alcohol copolymer.

In particular, good results are obtained when the at least one first coating layer of the capsule comprises at least one polyvinyl alcohol and/or polyvinyl alcohol copolymer having a weight average molecular weight, measured by gel permeation chromatography using a polystyrene standard, of from 9000 to 120000 g/mol and preferably from 13000 to 30000 g/mol. Such polyvinyl alcohols or polyvinyl alcohol copolymers form layers with sufficiently low gas permeability and are also easy to process, since they form solutions or dispersions with a suitable viscosity in water, so that they can be easily applied to the capsule body by dipping the capsule body in the solution or dispersion.

For the above reasons, it is preferred to use polyvinyl alcohol and/or polyvinyl alcohol copolymer which, in a 4% aqueous solution at 20° C. measured in accordance with DIN 53015, has a viscosity of from 3 to 110 mPa·s and, particularly preferably, from 3 to 20 mPa·s.

According to a particularly preferred embodiment of the present invention, the material of the at least one first coating layer as well as the thickness thereof are adjusted such that the first coating layer(s), at a layer thickness of 1 to 2 μm, has a gas permeability of less than 3cm³/m²/day/1.01325 MPa, preferably of less than 2 cm³/m²/day/1.01325 MPa and particularly preferably of less than 1 cm³/m²/day/1.01325 MPa.

According to the invention, the capsule body is fully encased by the at least one first coating layer.

In further development of the invention, it is proposed to coat the outermost of the at least one first coating layer of polyvinyl alcohol or polyvinyl alcohol copolymer with at least one second coating layer, wherein the at least one second coating layer comprises a polysaccharide. In this way, on the one hand, any dissolution of polyvinyl alcohol or polyvinyl alcohol copolymer from the capsule can be avoided when the capsule comes into contact with water or another liquid, and, on the other hand, the mechanical properties, such as stability, of the capsule can be adjusted to a desired value.

The feature that the capsule has at least one second coating layer means that the capsule comprises one or two or more interconnected layers of at least one polysaccharide, i.e. a corresponding single layer or a laminate of two or more layers applied to each other. When the capsule has two or more second coating layers, the above thickness is the total thickness of all the layers.

For example, to increase the stability of the capsule, it is preferred that the at least one second coating layer comprises a crosslinked polysaccharide obtained by crosslinking a polysaccharide with a crosslinking agent.

In principle, the present invention is not limited with respect to the chemical nature of the polysaccharide of the at least one second coating layer. In particular, good results are obtained when the polysaccharide of the at least one second coating layer is selected from the group consisting of starch, cellulose, chitin, carrageenan, agar and alginates. It is particularly preferred that the polysaccharide of the at least one second coating layer is a carrageenan or an alginate, and it is particularly preferred that the polysaccharide of the at least one second coating layer is an alginate. These polysaccharides do not cause any distortion of the taste during the preparation of the beverage. Moreover, it has been shown that capsule bodies of polysaccharide can be easily and inexpensively coated with alginate. In this regard, alginates are biodegradable and provide a sufficiently stable coating and protect the capsule contents without significant flavor loss. Furthermore, it has been shown that alginates are capable of reducing water hardness. In addition, an unpleasant acid taste is prevented or at least mitigated.

Preferably, the polysaccharide of the at least one second coating layer is crosslinked. In this regard, the crosslinking of the polysaccharide according to one embodiment of the present invention may be via covalent bonds. Crosslinking via covalent bonds enables very durable coatings. In this case, crosslinking via covalent bonds is usually carried out by reacting the polysaccharide with a suitable crosslinking agent. In particular, difunctional organic compounds are suitable as crosslinkers, the functional groups being selected, for example, from the group consisting of carboxylic acids, salts of carboxylic acids, activated carboxylic acids, amines, alcohols, aldehydes and ketones. In this context, activated carboxylic acids are understood to be carboxylic acid halides, active esters of carboxylic acids, anhydrides of carboxylic acids or other reactive derivatives of carboxylic acids.

In this regard, the crosslinking can be performed without the use of a spacer and, in particular, can be performed without a polyol spacer.

However, the crosslinking can also be carried out with a spacer and in particular with a polyol spacer. The polyol spacer is preferably an aliphatic, cyclic or aromatic polyol and particularly preferably ethylene glycol, propanetriol, triethylene glycol, polyethylene glycol, sorbitol, glucose, fructose, galactose, cyanidin, corilagin, digalic acid, gallic acid or tannic acid. Due to the polyolic spacer, a certain elasticity of the coating layer is achieved and the water absorption and vapour permeability can be specifically influenced.

According to an alternative and particularly preferred embodiment of the present invention, the polysaccharide of the at least one second coating layer is crosslinked via ionic and/or coordinative bonds. Such polysaccharides crosslinked via ionic and/or coordinative bonds are particularly easy to prepare and do not impair the biodegradability of the polysaccharide used. The ionic and/or coordinative cross-linking can be achieved, for example, by means of polysaccharides which have anionic groups, such as carboxylate groups or sulfonate groups. Ionic and/or coordinative crosslinking of the anionic groups of the polysaccharide is then achieved by introducing divalent or higher valent cations, in particular alkaline earth metal ions, to form a stable coating layer.

In this context, a coordinative bond refers to an interaction between an electron pair donor and an electron pair acceptor, such as can occur between free electron pairs of oxygen atoms in hydroxyl groups and cations.

Most preferably, the crosslinked polysaccharide is an alkaline earth metal alginate and most preferably a calcium alginate. In this case, the calcium ions are the crosslinking agent as they form coordinative or ionic bonds with groups of the alginate. It has been surprisingly found in the context of the present invention that a coating comprising calcium alginate provides a water insoluble layer which does not affect the taste of the beverage produced from the capsule, and provides sufficient stability of the capsule to ensure transport and touch protection without any appreciable loss of flavour to the capsule contents. In addition, calcium alginate has excellent biodegradability. Another advantage is that calcium alginate is an approved food additive with the E number E405 and is therefore harmless to health.

In further development of the invention, it is proposed that the at least one second coating layer comprises fibers so as to increase the mechanical stability of the at least one second coating layer. Preferably, the fibers may be polysaccharide fibers, as they are biodegradable, with good results being obtained in particular with cellulose fibers, such as cotton fibers. The fibers are preferably long fibers, and preferably those having a length of at least 100 μm, preferably at least 1 mm and particularly preferably at least 5 mm. These long fibres can then absorb high tensile forces in the layer.

As an alternative to fibers, or even in addition to fibers, yarns or fabrics made of such fibers may be provided in the at least one second coating layer.

In principle, the capsule according to the invention may comprise only a second coating layer of crosslinked polysaccharide. In order to increase the stability of the capsule and thus the transport safety and the touch protection, it is proposed in further development of the idea of the invention that the capsule according to the invention comprises two or more second coating layers. Preferably, the capsule body of the capsule is coated with 2 to 100, more preferably with 2 to 20, most preferably with 2 to 10 and most preferably with 2 to 5 second coating layers, i.e. with polysaccharide containing coating layers. By coating the capsule body of the capsule with two or more second coating layers, the effect of the coating as an oxygen barrier as well as the associated provision of effective aroma protection is also achieved to a particularly high extent.

According to another particularly preferred embodiment of the present invention, the second coating of the capsule body comprises from 2 to 100, preferably from 2 to 20, more preferably from 2 to 10 and most preferably from 2 to 5 calcium alginate layers, optionally comprising cellulose fibers.

The individual second coating layers have thicknesses between 40 and 600 μm, depending on the viscosity of the sodium alginate solution and the process used. Thicknesses of 70 to 300 μm for the first layer are particularly preferred, since they exhibit the optimum compromise between stability and drying speed. Subsequent coating layers are preferably thinner and are preferably between 40 and 200 μm to allow for fast drying.

A thin second coating layer is preferred in order to remove the water contained in the gel more easily and to facilitate the fastest possible diffusion of the crosslinking agent, i.e. the calcium ions, into the sodium alginate. In principle, the speed of diffusion of the calcium ions into the sodium alginate could also be increased by a higher concentration of the crosslinking agent; however, in the practical implementation of this variant, thin coating thicknesses have been shown to be advantageous for the speed of diffusion and handling.

It is indeed in principle possible, to only partially encase the capsule body of the capsule according to the invention with the at least one second coating layer. However, it is preferred that the capsule body is fully encased by the at least one second coating layer.

According to an alternative embodiment of the present invention, the capsule body is composed of one or more layers of uncrosslinked polysaccharide. In this embodiment, it is preferred to provide the capsule body of a fibrous polysaccharide to provide suitable mechanical stability to the capsule body. In particular, the fibrous polysaccharide may be fibrous material comprising starch, cellulose, chitin, carrageenan, agar and alginates. Particularly preferred is fibrous material made of cellulose fibers, since these are characterized by low prices and high strengths, in addition to high availability. Particularly preferred fibrous materials of which the capsule body is composed are paper, cardboard and paperboard. Preferably, the thickness of the capsule body is 0.1 to 10 mm, preferably 0.25 to 2.5 mm and particularly preferably 0.5 to 1.5 mm.

According to an alternative preferred embodiment of the present invention, the capsule body is composed of one or more layers of crosslinked polysaccharide. In this embodiment, it is preferred that the capsule body is composed of one or more layers of cross-linked polysaccharide. Preferably, the capsule body is composed of one or more layers of alginate. In this regard, it is particularly preferred if the alginate is an alkaline earth metal alginate, in particular calcium alginate, optionally comprising cellulose fibers.

According to an alternative preferred embodiment of the present invention, the capsule body may also be composed of one or more layers of uncrosslinked polysaccharide (preferably a fibrous polysaccharide comprising a fibrous material selected from starch, cellulose, chitin, carrageenan and agar and more preferably paper, cardboard or paperboard) and one or more layers of crosslinked polysaccharide (preferably one or more layers of alginate and more preferably calcium alginate) applied thereto. In particular in this embodiment, it is preferred that the polysaccharide-containing material with which the capsule body is filled is in the form of a pellet, the pellet preferably having been obtained by pressing at a pressure of 0.01 to 1000 MPa, preferably 0.05 to 500 MPa, more preferably 0.1 to 100 MPa, further preferably 0.5 to 100 MPa, still more preferably 1 to 100 MPa, most preferably 5 to 50 MPa and most preferably 15 to 30 MPa.

Another object of the present invention is to provide a method of making a capsule according to any one of the preceding claims, comprising the steps of:

i) providing a capsule body composed of at least one polysaccharide and filled with a material,

ii) wetting the entire surface of the capsule body provided in step i) with a solution of a polyvinyl alcohol and/or a polyvinyl alcohol copolymer in a solvent or with a dispersion of a polyvinyl alcohol and/or a polyvinyl alcohol copolymer in a dispersant,

(iii) drying the capsule body obtained in step (ii); and

iv) optionally repeating steps ii) to iii) for 1 to 10 times, preferably 1 to 5 times and more preferably 1 to 3 times.

Preferably, the capsule body is provided in step i) by filling an uncrosslinked polysaccharide, preferably paper, cardboard or paperboard, with a polysaccharide-containing powder.

It is further preferred that the capsule body is provided in step i) by wetting a part and preferably the entire surface of a pellet of a polysaccharide-containing powder with a solution of a polysaccharide in a solvent or with a dispersion of a polysaccharide in a dispersant, thereafter contacting it with at least one crosslinking agent, and subsequently drying it.

Alternatively, it is preferred that the capsule body is provided in step i) by filling an uncrosslinked polysaccharide, preferably paper, cardboard or paperboard, with a polysaccharide-containing powder, and thereafter wetting a part and preferably the entire surface of the filled uncrosslinked polysaccharide with a solution of a polysaccharide in a solvent or with a dispersion of a polysaccharide in a dispersing agent, thereafter contacting it with at least one crosslinking agent and subsequently drying it.

Preferably, a part and more preferably the entire surface of the capsule body obtained in step iii) or iv) is wetted with a solution of a polysaccharide in a solvent or with a dispersion of a polysaccharide in a dispersing agent, is then brought into contact with at least one crosslinking agent and is then dried, optionally repeating these steps for 1 to 10 times, preferably 1 to 5 times and more preferably 1 to 3 times.

Another object of the present invention is to use the capsule according to the invention for preparing a beverage by bringing the capsule according to the invention into contact with water. Preferably, the capsule contains a material selected from the group consisting of coffee, tea, drinking chocolate, cocoa and milk powder.

The use of the capsule according to the invention for the preparation of a coffee beverage allows the beverage to be prepared in portions as required. A particular advantage of the use according to the invention is that only biodegradable waste is produced.

When using the capsule according to the invention for preparing a beverage, in particular a coffee beverage, the coffee capsule is preferably crushed or perforated before subsequent extraction of the crushed or perforated coffee capsule with water.

The present invention will be explained below with reference to three examples illustrative, but not limiting, of the invention.

### EXAMPLE 1

6.5 g of ground roasted coffee was pressed into a spherical pellet using a press. The resulting spherical pellet was immersed in a 1.5 wt % aqueous sodium alginate solution and removed from the sodium alginate solution after 1 to 2 seconds. After the pellet was removed from the sodium alginate solution, it was sprayed with a 5 wt % CaCl₂ solution. The pellet was then air dried for 15 minutes at room temperature.

A capsule consisting of a pellet with a coating layer of calcium alginate was obtained.

The obtained capsule was immersed in 5 wt % aqueous polyvinyl alcohol solution (Kuraray Exceval AQ-4104) and removed from the polyvinyl alcohol solution after 1 to 2 seconds. After removal of the capsule, it was dried for 5 minutes at room temperature in the air stream.

A spherical capsule was obtained that was fully encased, had no cracks or holes, and had a film thickness for polyvinyl alcohol in the range of less than 5 μm.

It was shown that this thin layer of polyvinyl alcohol is already sufficient to achieve a very high oxygen tightness.

### EXAMPLE 2

A coffee capsule was prepared as in Example 1. Thereafter, this capsule was immersed in a 1.5 wt % aqueous sodium alginate solution and removed from the sodium alginate solution after 1 to 2 seconds. After the capsule was removed from the sodium alginate solution, it was sprayed with a 5 wt % CaCl₂ solution. The capsule was then air dried for 15 minutes at room temperature.

A capsule was obtained which had gained strength from the outer calcium alginate layer and which prevented the polyvinyl alcohol from the interlayer from going into solution during the brewing process.

### EXAMPLE 3

A cup-shaped capsule body with an upper rim was formed from papier mâchéand dried. This capsule base body was filled with 6.5 g of ground roasted coffee. The filled capsule body was then sealed with a paper cap, which was glued to the capsule body rim with a methyl cellulose. The capsule thus sealed was immersed in a 1.5 wt % aqueous sodium alginate solution and removed from the sodium alginate solution after 1 to 2 seconds. After the capsule was removed from the sodium alginate solution, it was sprayed with a 5 wt % CaCl₂ solution. The capsule was then air dried for 15 minutes at room temperature.

A capsule was obtained consisting of a base body formed of paper, filled with coffee grounds, with a coating layer of calcium alginate.

The obtained capsule was immersed in 5 wt % aqueous polyvinyl alcohol solution (Kuraray Exceval AQ-4104) and removed from the polyvinyl alcohol solution after 1 to 2 seconds. After removal of the capsule, it was dried for 5 minutes at room temperature in the air stream.

A cup-shaped capsule was obtained, which was fully sheathed, had no cracks or holes and had a layer thickness for polyvinyl alcohol in the range of less than 5 μm.

It turned out that this thin layer of polyvinyl alcohol is already sufficient to achieve a very high oxygen tightness.

1. A capsule comprising a capsule body composed of at least one polysaccharide and filled with a polysaccharide-containing material, the capsule body being entirely encased by at least one first coating layer, the at least one first coating layer comprising at least one polyvinyl alcohol and/or a polyvinyl alcohol copolymer.

2. The capsule according to claim 1, wherein the polysaccharide-containing material with which the capsule body is filled is selected from the group consisting of coffee, tea, drinking chocolate, cocoa and milk powder.

3. The capsule according to claim 1, wherein the at least one first coating layer has a thickness of from 0.5 to 10 μm.

4. The capsule according to claim 1, wherein the at least one first coating layer comprises at least one polyvinyl alcohol and/or polyvinyl alcohol copolymer having a weight average molecular weight, measured by gel permeation chromatography using a polystyrene standard, of from 9000 to 120000 g/mol.

5. The capsule according to claim 1, wherein the at least one first coating layer has, at a layer thickness of 1 to 2 μm, a gas permeability of less than 3 cm³/m²/day/1.01325 MPa.

6. The capsule according to claim 1, wherein the at least one first coating layer comprises 1 to 5, layer(s), each comprising at least one polyvinyl alcohol and/or a polyvinyl alcohol copolymer.

7. The capsule according to claim 1, wherein the outermost of the at least one first coating layer is coated with at least one second coating layer, wherein the at least one second coating layer comprises a polysaccharide.

8. The capsule of claim 7, wherein said at least one second coating layer comprises a crosslinked polysaccharide selected from the group consisting of starch, cellulose, chitin, carrageenan, agar and alginates.

9. The capsule according to claim 8, wherein the polysaccharide of the at least one second coating layer is an alginate.

10. The capsule according to claim 8, wherein the at least one second coating layer comprises fibres.

11. The capsule according to claim 1, wherein the capsule body is composed of one or more layers of uncrosslinked polysaccharide.

12. The capsule according to claim 1, wherein the capsule body is composed of one or more layers of crosslinked polysaccharide.

13. The capsule according to claim 1, wherein the polysaccharide-containing material with which the capsule body is filled is present as a pellet.

14. A method of making a capsule according to claim 1, comprising the steps of:
i) providing a capsule body composed of at least one polysaccharide and filled with a polysaccharide-containing material,
ii) wetting the entire surface of the capsule body provided in step i) with a solution of a polyvinyl alcohol and/or a polyvinyl alcohol copolymer in a solvent or with a dispersion of a polyvinyl alcohol and/or a polyvinyl alcohol copolymer in a dispersant,
(iii) drying the capsule body obtained in step (ii); and
iv) optionally repeating steps ii) to iii) for 1 to 10 times.

15. (canceled)

16. The capsule according to claim 9, wherein the alginate is an alkaline earth metal alginate.

17. The capsule according to claim 10, wherein the fibres are cellulose fibres.

18. The capsule according to claim 11, wherein the uncrosslinked polysaccharide is cellulose.

19. The capsule according to claim 11, wherein the uncrosslinked polysaccharide is paper, cardboard or paperboard.

20. The capsule according to claim 12, wherein crosslinked polysaccharide is an alginate.

21. The capsule according to claim 13, wherein the pellet was obtained by pressing at a pressure of 0.01 to 1000 MPa.
